(19) United States
(12) Patent Application Publication
(10) Pub. No.: US 2022/0343256 A1
(43) Pub. Date: Oct. 27, 2022

(54) SYSTEM AND METHOD FOR DETERMINING INSTRUCTOR EFFECTIVENESS SCORES IN INTERACTIVE ONLINE LEARNING SESSIONS

(71) Applicant: Vedantu Innovations Pvt. Ltd., Bangalore (IN)

(72) Inventors: Pranav R. MALLAR, Bengaluru (IN); Pulkit JAIN, Bengaluru (IN)

(73) Assignee: Vedantu Innovations Pvt. Ltd., Bangalore (IN)

(21) Appl. No.: 17/352,701

(22) Filed: Jun. 21, 2021

(30) Foreign Application Priority Data
Apr. 26, 2021 (IN) 202141019199

(51) Int. Cl. G06Q 10/06; G06N 20/00; G06N 5/04; G06Q 50/20; G06Q 30/02

(52) U.S. Cl. CPC G06Q 10/06398; G06N 20/00; G06N 5/04; G06Q 50/205; G06Q 30/0282; H04L 67/12

(57) ABSTRACT

A system for determining instructor effectiveness scores for interactive learning sessions delivered via an online learning platform to a plurality of learners is presented. The system includes a data module and a processor. The data module is operatively coupled to the online learning platform and a computing device used by an instructor to deliver the online learning sessions, the data module configured to access in-session data, post-session data, and content metadata for a first plurality of learning sessions delivered by the instructor. The processor is operatively coupled to the data module, and includes a feature generator, a score estimator, and a notification module.

### PRIORITY STATEMENT

The present application claims priority under 35 U.S.C. § 119 to Indian patent application number 202141019199 filed Apr. 26, 2021, the entire contents of which are hereby incorporated herein by reference.

### BACKGROUND

Embodiments of the present invention generally relate to systems and methods for determining instructor effectiveness scores in interactive online learning sessions, and more particularly to automated systems and methods for determining instructor effectiveness scores in interactive online learning sessions.

Online learning systems represent a wide range of methods for the electronic delivery of information in an education or training setup. More specifically, interactive online learning systems are revolutionizing the way education is imparted. Such interactive online learning systems offer an alternate platform that is not only faster and potentially better but also bridges the accessibility and affordability barriers for the learners. Moreover, online learning systems provide learners with the flexibility of being in any geographic location while participating in the session.

Apart from providing convenience and flexibility, such online learning systems also ensure more effective and engaging interactions in a comfortable learning environment. With the advancement of technology, personalized interactive sessions are provided according to specific needs rather than just following a set pattern of delivering knowledge as prescribed by conventional educational institutions. Moreover, such a system allows a mobile learning environment where learning is not time-bound (anywhere-anytime learning).

However, there is a need to monitor such interactions and to measure the effectiveness of instructors delivering the sessions. Currently, the effectiveness of such interactive learning sessions is manually reviewed (e.g., by delivering quizzes and/or taking feedbacking surveys). Such manual interventions could be time-consuming and less scalable. Moreover, reviews done in such a manner lead to subjective and inaccurate ratings.

Thus, there is a need for automated systems and methods capable of determining the effectiveness of instructors in online interactive learning sessions.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a system for determining instructor effectiveness scores for interactive learning sessions delivered via an online learning platform to a plurality of learners is presented. The system includes a data module and a processor. The data module is operatively coupled to the online learning platform and a computing device used by an instructor to deliver the online learning sessions, the data module configured to access in-session data, post-session data, and content metadata for a first plurality of learning sessions delivered by the instructor. The processor is operatively coupled to the data module, and includes a feature generator, a score estimator, and a notification module. The feature generator is configured to generate a plurality of instructor features based on the in-session data, the post-session data, and the content metadata. The score estimator is configured to estimate a composite instructor effectiveness score for the first plurality of learning sessions based on an AI model, the plurality of instructor features, and historical data for a second plurality of learning sessions, wherein the second plurality of learning sessions corresponds to a learning goal and a learning topic that is same as the first plurality of learning sessions. The notification module is configured to notify the instructor effectiveness score to at least one of the instructor and the online learning platform.

According to another example embodiment, a system for determining instructor effectiveness scores in interactive learning sessions delivered via an online learning platform to a plurality of learners is presented. The system includes a memory storing one or more processor-executable routines and a processor cooperatively coupled to the memory. The processor is configured to execute the one or more processor-executable routines to access in-session data, post-session data, and content metadata for a first plurality of learning sessions delivered by an instructor; generate a plurality of instructor features based on the in-session data, the post-session data, and the content metadata; estimate a composite instructor effectiveness score for the first plurality of learning sessions based on an AI model, the plurality of instructor features and historical data for a second plurality of learning sessions, wherein the second plurality of learning sessions corresponds to a learning goal and a learning topic that is same as the first plurality of learning sessions; and notify the instructor effectiveness score to at least one of the instructor and the online learning platform.

According to another example embodiment, a method for determining instructor effectiveness scores for interactive learning sessions delivered via an online learning platform is presented. The method includes accessing in-session data, post-session data, and content metadata for a first plurality of learning sessions delivered by an instructor; generating a plurality of instructor features based on the in-session data, the post-session data, and the content metadata; estimating a composite instructor effectiveness score for the first plurality of learning sessions based on an AI model, the plurality of instructor features and historical data for a second plurality of learning sessions, wherein the second plurality of learning sessions corresponds to a learning goal and a learning topic that is same as the first plurality of learning sessions; and notifying the instructor effectiveness score to at least one of the instructor and the online learning platform.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram illustrating an example online learning environment, according to some aspects of the present description,

FIG. 2 is a block diagram illustrating an example data module communicatively coupled to a plurality of learner computing devices and an instructor computing device, according to some aspects of the present description,

FIG. 3 is a block diagram illustrating an example data module communicatively coupled to an instructor computing device, according to some aspects of the present description,

FIG. 4 is a block diagram illustrating an example system for estimating instructor effectiveness scores, according to some aspects of the present description,

FIG. 5 is a block diagram illustrating an example system for estimating instructor effectiveness scores, according to some aspects of the present description,

FIG. 6 is a flow chart illustrating an example method for estimating instructor effectiveness scores, according to some aspects of the present description,

FIG. 7 is a plot showing a composite instructor effectiveness score and a baseline instructor effectiveness score, according to some aspects of the present description,

FIG. 8 shows the split of composite effectiveness score into a whiteboard usage score, an interaction score, and a content usage score, according to some aspects of the present description,

FIG. 9 shows examples of pedagogical instructions notified to an instructor, according to some aspects of the present description, and

FIG. 10 is a block diagram illustrating an example computer system, according to some aspects of the present description.

### DETAILED DESCRIPTION OF EXAMPLE EMBODIMENTS

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently, or simultaneously. In addition, the order of operations may be re-arranged. The processes may be terminated when their operations are completed, but may also have additional steps not included in the figures. It should also be noted that in some alternative implementations, the functions/acts/steps noted may occur out of the order noted in the figures. For example, two figures shown in succession may, in fact, be executed substantially concurrently or may sometimes be executed in the reverse order, depending upon the functionality/acts involved.

Further, although the terms first, second, etc. may be used herein to describe various elements, components, regions, layers, and/or sections, it should be understood that these elements, components, regions, layers, and/or sections should not be limited by these terms. These terms are used only to distinguish one element, component, region, layer, or section from another region, layer, or a section. Thus, a first element, component, region, layer, or section discussed below could be termed a second element, component, region, layer, or section without departing from the scope of example embodiments.

Spatial and functional relationships between elements (for example, between modules) are described using various terms, including “connected,” “engaged,” “interfaced,” and “coupled.” Unless explicitly described as being “direct,” when a relationship between first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Example embodiments of the present description provide automated systems and methods for determining instructor effectiveness scores, using a trained AI model, in interactive learning sessions delivered via an online learning platform to a plurality of learners.

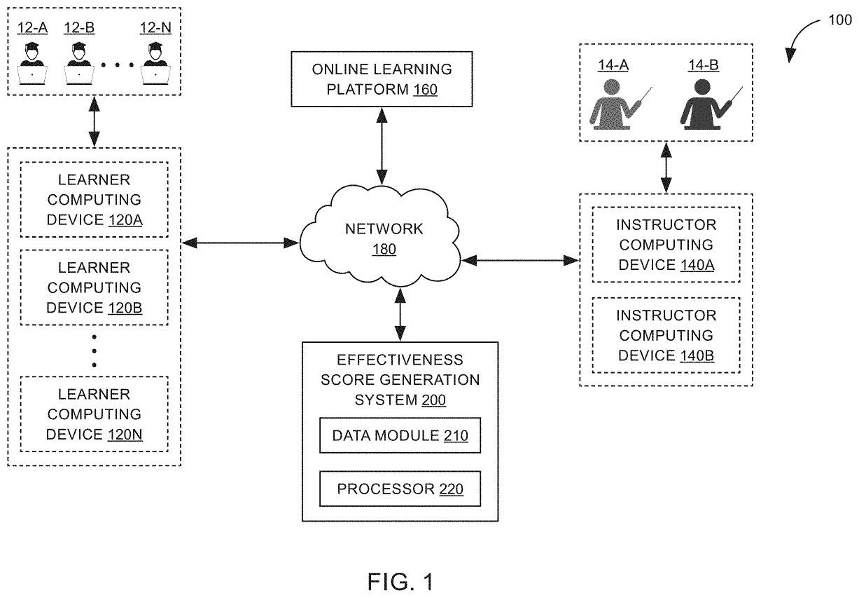

FIG. 1 illustrates an example online interactive learning environment 100 configured to provide an interactive learning session (which is hereafter simply referred to as the “learning session”), in accordance with some embodiments of the present description. The term “interactive learning session” as used herein refers to live learning sessions (e.g., using at least live audio or video) delivered via online learning platforms by the instructors, which allow for real-time interactions between the instructors and the learners. This is in contrast to pre-recorded learning sessions that are available on online learning platforms.

The online interactive learning environment includes a plurality of learners 12A, 12B . . . 12N (collectively represented by reference numeral 12) and one or more instructors 14A, 14B (collectively represented by reference numeral 14). As used herein, the term “instructor” refers to an entity that is imparting information to the plurality of learners 12 during the learning session. It should be noted that although FIG. 1 shows two instructors for illustration purposes, the number of instructors may vary, and may depend on the learning requirements of the learning session. In some instances, the number of instructors may depend on the number of learners attending the learning session. The plurality of learners 12 may include more than 20 learners in some embodiments, more than 100 learners in some embodiments, and more than 500 learners in some other embodiments.

Non-limiting examples of such interactive sessions may include training programs, seminars, classroom sessions, and the like. In some embodiments, the instructor is a teacher, the learner is a student, and the interaction session is aimed at providing educational content. In such instances, the plurality of learners 12 may collectively constitute a class. As noted earlier, the plurality of learners 12 may be located at different geographical locations while engaging in the online interactive learning session and may belong to the same or different demographics.

The online learning environment 100 further includes a plurality of learner computing devices 120A, 120B . . . 120N. The learner computing devices are configured to facilitate the plurality of learners 12 to engage in the online learning session, according to aspects of the present technique. Non-limiting examples of learner computing devices include personal computers, tablets, smartphones, and the like. In the embodiment illustrated in FIG. 1, each learner computing device corresponds to a particular learner, e.g., learner computing device 120A corresponds to learner 12A, learner computing device 120B to learner 12B, and so on.

Similarly, the online learning environment 100 further includes a plurality of instructor computing devices 140A and 140B. The instructor computing devices are configured to facilitate the plurality of instructors to deliver the online learning session. Non-limiting examples of instructor computing devices include personal computers, tablets, smartphones, and the like. In the embodiment illustrated in FIG. 1, each instructor computing device corresponds to a particular instructor, e.g., instructor computing device 140A corresponds to instructor 14A, instructor computing device 140B to instructor 14B, and so on.

The interactive online learning environment 100 further includes an online learning platform 160. The online learning platform 160 is used by the plurality of learners 12 to access the learning sessions and by the one or more instructors 14 to deliver the learning sessions. The learning sessions are delivered by the one or more instructors live (e.g., in a virtual live classroom) via the learning platform 160. The learning platform 160 may be accessed via a web page or an app on the plurality of computing devices used by the plurality of learners 12. As described in detail later, the online learning platform 160 includes one or more interactive tools that facilitate interaction between the plurality of learners 12 or between the plurality of learners 12 and the one or more instructors 14, in real-time.

The various components of the online learning environment 100 may communicate through the network 180. In one embodiment, the network 180 uses standard communications technologies and/or protocols. Thus, the network 180 can include links using technologies such as Ethernet, 802.11, worldwide interoperability for microwave access (WiMAX), 3G, digital subscriber line (DSL), asynchronous transfer mode (ATM), InfiniBand, PCI Express Advanced Switching, etc. Similarly, the networking protocols used on the network 180 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc.

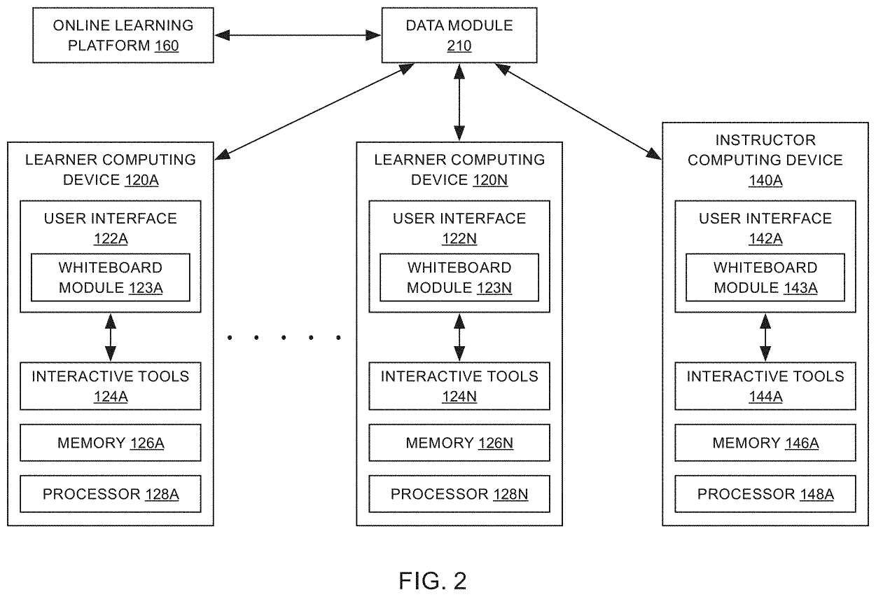

The online learning environment 100 further includes an effectiveness score estimation system 200 (hereinafter referred to as “system”) for determining instructor effectiveness scores for learning sessions delivered by the online learning platform 160. The system 200 includes a data module 210 and a processor 220. Each of these components is described in detail below with reference to FIGS. 2-4. In FIGS. 2-4, the system 200 is described herein with reference to instructor 14A. However, the system 200 may also be configured to estimate effectiveness scores for other instructors (if present).

As shown in FIG. 2, the data module 210 is operatively coupled to the online learning platform 160 and a computing device 140A used by an instructor 140A to deliver the online learning sessions. The data module 210 is configured to access one or more of in-session data, post-session data, and content metadata for a first plurality of learning sessions delivered by the instructor 14A. The data module 210 may be configured to access the in-session data, the post-session data, and the content metadata from the computing device 140A associated with the instructor 14A as well as from the online learning platform 160. The data module 210 may be further configured to access the in-session data from the computing devices associated with the learners.

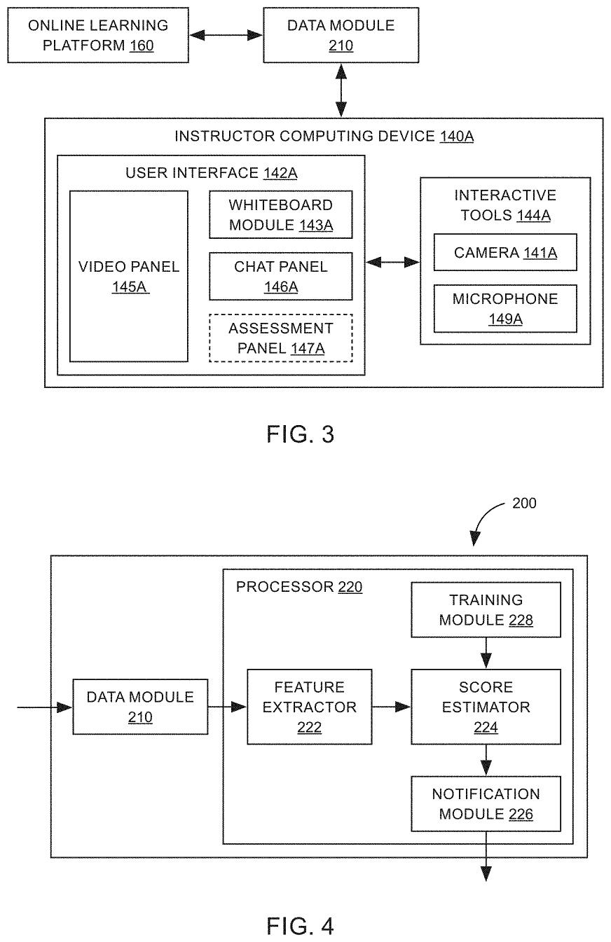

FIGS. 2 and 3 illustrate an example embodiment where the data module 210 is configured to access in-session data from the instructor 14A and the learning platform 160. As shown in FIGS. 2 and 3, data module 210 is communicatively coupled to the plurality of computing devices 120A . . . 120N used by the plurality of learners 12 to engage in the online learning session. The data module 210 is also communicatively coupled to the computing devices 140A used by the instructor 14A to deliver the online learning session (not shown in FIGs.). The learner computing devices 120A . . . 120N include among other components, user interface 122A . . . 122N, interactive tools 124A . . . 124N, memory unit 126A . . . 126N, and processor 128A . . . 128N. Similarly, the instructor computing device 140A includes among other components, user interface 142A, interactive tools 144A, memory unit 146A, and processor 148A.

FIG. 3 illustrates an instructor computing device 140A in more detail. The user interface 142A of the instructor computing device 140A includes the whiteboard module 143A, a video panel 145A, a chat panel 146A, and optionally an assessment panel 147A. Interactive tools 144A may include, for example, a camera 141A and a microphone 149A, and are used to capture video, audio, and other inputs from the learner 14A.

Whiteboard module 143A is configured to enable the learners 12 and the one or more instructors 14 to communicate amongst each other by initiating an interaction session by submitting written content. Examples of written content include alpha-numeric text data, graphs, figures, scientific notations, gifs, and videos. The whiteboard module 143A may further include formatting tools that would enable each user to ‘write’ in the writing area. Examples of formatting tools may include a digital pen for writing, a text tool to type in the text, a color tool for changing colors, a shape tool used for generating figures and graphs. In addition, an upload button may be included in the whiteboard module 143A for uploading images of pre-written questions, graphs, conceptual diagrams, and other useful/relevant animation representations.

Video panel 145A is configured to display video signals of a selected set of participants of the learning session. In one embodiment, the video data of a participant (learner or instructor) that is speaking at a given instance is displayed on the video panel 145A. Chat panel 146A is configured to enable all participants to message each other during the course of the learning session. In one embodiment, the messages in the chat panel 146A are visible to all participants engaged in the learning session.

The interactive tools 144A may include a camera 141 A for obtaining and transmitting video signals and a microphone 149A for obtaining audio input. In addition, the interactive tools 144A may also include a mouse, touchpad, keyboard, and the like.

In some embodiments, the instructor computing device 140A may further include an assessment panel 147A. The assessment panel 147A is configured to enable an instructor to deliver different in-session assessments (e.g., quizzes, hot spot-interactions, and the like) during the course of the learning session.

As noted earlier, the data module 210 is configured to access in-session data for a first plurality of learning sessions. Non-limiting examples of in-session data include whiteboard data, audio data, video data, content data, or interaction data for the instructor corresponding to each learning session of the first plurality of learning sessions. In some embodiments, the in-session data further includes a learner metric for each learning session of the first plurality of learning sessions.

The term “audio data” as used herein refers to the audio content recorded from the microphones of the corresponding computing devices as well as the data accessed by processing the audio content such as tonality, flow, sentiment, confidence levels, and the like. Non-limiting examples of audio data include language spoken, keywords used, voice modulation, tone, speaking rate, pause and flow metric of audio, emphasis, enunciation, sentiment, articulation, stress, confidence level, and the like.

The voice modulation data may be used to estimate break periods of monotone. Articulation data may be generated based on emphasis and enunciation data measured. Pause and flow of speech corresponding to whiteboard may be tokenized based on expected behavior and measured. The confidence level data may be generated based on the tone, emphasis, and articulation of an instructor.

The term “video data” as used herein refers to the video content recorded from the cameras of the corresponding computing devices as well as the data accessed by processing the video content such as emotion, camera presence, and the like. Non-limiting examples of video data include emotion metric, camera presence, or combinations thereof. The video data may be generated by identifying and categorizing gestures, body language, camera presence, emotions, or the appearance of the instructor.

The term “whiteboard data” as used herein refers to the whiteboard content recorded from the whiteboard modules of the corresponding computing devices. Non-limiting examples of whiteboard data include writing length of the written content, writing time of written content, number of pages used in the whiteboard module, colours used in the whiteboard module, figures, graphs, images, gifs, or videos uploaded to the whiteboard module, relevancy to the interaction session of the whiteboard data submitted to the whiteboard module, ambiguity in whiteboard data, or combinations thereof.

The term “content data” as used herein refers to data corresponding to the content used by the instructor to deliver the first plurality of learning sessions. Non-limiting examples of content data include topic-wise time taken by the instructor or the type of content used (e.g., image/audio/video, etc.).

The term “interaction data” as used herein refers to data corresponding to one or more of interaction elements (such as in-session quizzes, in-session prompts/questions, hotspot interactions, and the like) employed by the instructor during the first plurality of learning sessions, messaging data between the instructor and the learners, and doubts data. Non-limiting examples of interaction data include flow and frequency of interaction elements like in-session quizzes, messages, doubts, and the like.

The term “in-session quiz” as used herein refers to in-session assessments/tests that are administered during a learning session itself. In some embodiments, the in-session quizzes are administered by the in-session assessment panel. The term “hotspot” as used herein refers to a visible location on a screen that is linked to performing a specified task. Non-limiting examples of hotspot interactions may include selecting/matching a set of images, filling in the blanks, etc.

The term “messaging data” as used herein refers to the messaging content recorded from the chat modules of the corresponding computing devices as well as the data accessed by processing the messaging content. Non-limiting examples of messaging data include classification of messages (e.g., answers versus questions), frequency of messages that are classified as questions, and the like.

The term “doubts data” as used herein refers to any data related to doubts submitted by a learner for a particular learning session. Non-limiting examples of doubts data include types of doubts (e.g., open-ended or close-ended questions), frequency of open-ended questions, satisfactoriness of answers provided by the instructor to the open-ended questions, and the like.

In some embodiments, the in-session data further includes a learner metric for each learning session of the first plurality of learning sessions. The term “learner metric” may refer to a metric that measures the engagement level of a plurality of learners attending the first plurality of learning sessions. In some embodiments, the learner metric may correspond to a learner engagement score generated in real-time during a live learning session using an AI model. The learner metric may be calculated based on in-session data from the plurality of learners, such as video data, audio data, content data, whiteboard data, in-session assessment data, and the like.

As noted earlier, the data module 210 is further configured to access the post-session data for one or more learning sessions. Non-limiting examples of post-session data include feedback survey data, post-session assessment data, learner conversion data, learner churn data, or combinations thereof.

Feedback survey data includes data from feedback surveys submitted by a learner after completing one or more learning sessions. In some embodiments, the feedback survey data may be submitted by the learner on the online learning platform 160 after the completion of the first plurality of learning sessions.

The term “post-session assessment data” as used herein refers to data obtained from post-session tests and/or assignments completed by a learner after attending the first plurality of learning sessions. Non-limiting examples of test metrics include the total number of tests given, total number of tests taken, total number of questions attempted, accuracy of the attempted questions, total number of incorrect questions, type of mistakes, time spent on accurate answers, time spent on inaccurate answers, levels of questions answered, total number of assignments given, total number of assignments taken, accuracy on the assignments, and the like.

The term “learner conversion data” refers to the percentage of learners that enroll for one or more learning courses after a learning session of the first plurality of learning sessions is completed. The term “learner churn data” as used herein refers to the percentage of learners that drop out after a learning session of the first plurality of learning sessions is completed.

The data module 210 is further configured to access content metadata corresponding to the first plurality of learning sessions. The term “content metadata” as used herein refers to metadata annotated and tagged with the presentation used by the instructor to deliver a learning session of the first plurality of learning sessions. Non-limiting examples of content metadata may include data corresponding to the learning session (e.g., goal, topic, sub-topic, etc.), data corresponding to each slide (e.g., factoid, problem, interaction, etc.), or combinations thereof.

As noted earlier, the system 200 further includes a processor 220. FIG. 4 illustrates an example effectiveness score generation system 200 including the data module 210 and the processor 220. The processor 220 includes a feature generator 222, an effectiveness score estimator 224, and a notification module 226. Each of these components is further described in detail below.

The feature generator 222 is configured to generate a plurality of instructor features based on the in-session data, the post-session data, and the content metadata. In some embodiments, the feature generator 222 is configured to generate a plurality of in-session features based on the in-session data; a plurality of post-session features based on the post-session data, and a plurality of content features based on the content meta-data. The plurality of instructor features may be generated using one or more AI models.

The effectiveness score estimator 224 (referred to herein as “score estimator”) is configured to estimate a composite instructor effectiveness score for the first plurality of learning sessions based on an AI model, the plurality of instructor features, and historical data for a second plurality of learning sessions. Non-limiting examples of suitable AI models include long short-term memory networks, convolutional neural networks, or a combination thereof.

The second plurality of learning sessions corresponds to a learning goal and a subject that is the same as the first plurality of learning sessions. The term “learning goal” as used herein refers to a target outcome desired from the learning session. Non-limiting examples of learning goals may include: studying for a particular grade (e.g., grade VI^{th}, grade X^{th}, grade XII^{th}, and the like), tuitions related to a particular grade, qualifying for a specific entrance exam (e.g, JEE, NEET, GRE, GMAT, SAT, LSAT, MCAT, etc.), or competing in national/international competitive examinations (e.g., Olympiads).

The second plurality of learning sessions may be further related to the same topic in a subject as the first plurality of learning sessions, for a particular learning goal. For example, in an example embodiment, where the first plurality of learning sessions is related to optics (topic) in physics (subject) for grade X^{th}, the second plurality of learning sessions may include all sessions related to X^{th}-grade physics (which includes all optics-related sessions), or may only include all sessions related to X^{th}-grade optics.

The term “composite instructor effectiveness score” as used herein refers to an overall effectiveness score for an instructor estimated for a set of learning sessions corresponding to a particular topic and a learning goal. The score estimator 224 is further configured to estimate an individual instructor effectiveness score for each learning session of the first plurality of learning sessions, and wherein the composite instructor effectiveness score is estimated based on the individual instructor effectiveness scores.

In some embodiments, the score estimator 224 is further configured to split the composite instructor effectiveness score into two or more of a whiteboard usage score, a content usage score, an interaction score, a behavior score, a pedagogical score, or an emotional score.

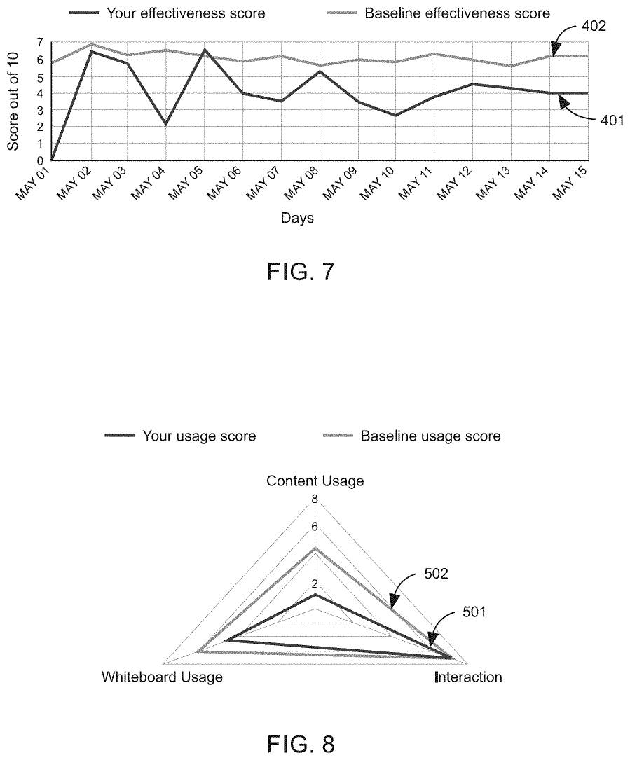

The notification module 226 is configured to notify the instructor effectiveness score to at least one of the instructor and the online learning platform. In some embodiments, the notification module 226 is configured to notify the composite instructor effectiveness score to the instructor after the completion of the first plurality of learning sessions. In some embodiments, the instructor may be able to access the scores via a personal dashboard on the online learning platform 160. FIG. 7 is a plot showing an example composite instructor effectiveness score 401 and a baseline instructor effectiveness score 402, according to some aspects of the present description. FIG. 8 shows an example of the split of the composite effectiveness score 501 into a whiteboard usage score, an interaction score, and a content usage score vis-à-vis a baseline instructor effectiveness score 502, according to some aspects of the present description.

In some embodiments, the notification module 226 may notify the instructor effectiveness scores to the online learning platform 160, and the scores may be employed by the online learning platform 160 to assess an instructor's performance vis-à-vis a baseline score and/or performance of other instructors on the online platform 160.

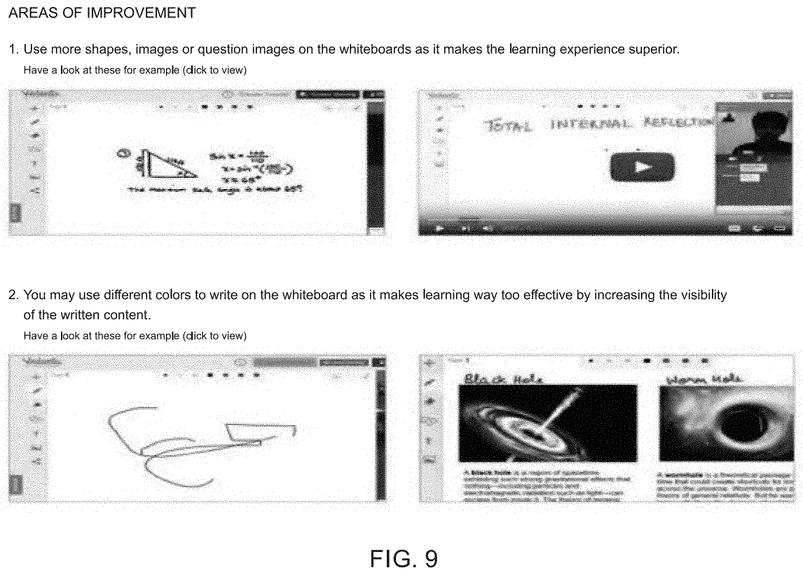

In some embodiments, the notification module 226 is configured to transmit one or more pedagogical suggestions to the instructor if the composite effectiveness score is below a threshold effectiveness score. The notification module 226 may be further configured to transmit one or more pedagogical suggestions (e.g., change in pedagogy, increased use of whiteboard module, etc.) to the instructor based on one or more of the whiteboard usage score, the content usage score, the interaction score, the behavior score, the pedagogical score, or the emotional score. FIG. 9 shows examples of pedagogical instructions notified to an instructor.

The instructor, in some embodiments, may make one or more changes in the delivery of the subsequent learning sessions, based on the composite effectiveness score and/or one or more suggestions. Thus, the systems and methods of the present description may enable changes in the delivery of a learning session by an instructor, based on the effectiveness scores.

Referring again to FIG. 4, the processor 220 may further include a training module 228 configured to train the AI model based on at least one of a learner metric or a manual evaluation data corresponding to one or more learning sessions of the first plurality of learning sessions.

As noted earlier, “learner metric” refers to a metric that measures the engagement level of a plurality of learners attending the first plurality of learning sessions. In some embodiments, the learner metric may correspond to a learner engagement score generated in real-time during a live learning session using an AI model. The learner metric may be calculated based on in-session data from the plurality of learners, such as video data, audio data, content data, whiteboard data, in-session assessment data, and the like.

The term “manual evaluation data” as used herein refers to data obtained by an in-person evaluation of one or more learning sessions of the plurality of learning sessions by one or more evaluators. In some embodiments, the one or more evaluators may evaluate the one or more learning sessions based on one or more of a manual whiteboard usage score, a manual content usage score, a manual interaction score, a manual behavior score, a manual pedagogical score, or a manual emotional score. In some embodiments, the one or more evaluators may further assign a manual composite effectiveness score to the one or more learning sessions. The training module 228 may be further configured to train the AI model based on or more additional suitable data, not described herein.

At least one of the learner metric and the manual evaluation data may be used as training data for the training module 228. In some embodiments, the training module 228 is configured to train the AI model at defined intervals, e.g., weekly, bi-weekly, fortnightly, monthly, etc. In such instances, the training data may be presented to the training module 224 at a frequency determined by a training schedule. In some other embodiments, the training module 228 is configured to train the AI model continuously in a dynamic manner. In such embodiments, the training data may be presented to the training module 228 continuously. The training module 228 is further configured to present the trained AI model to the assessment score estimator 224.

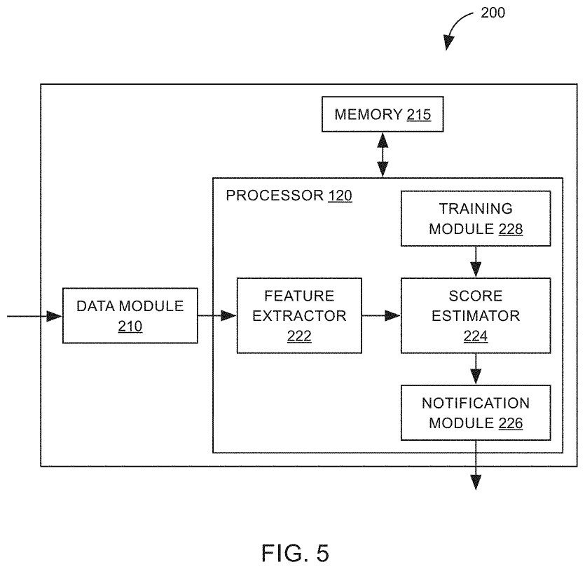

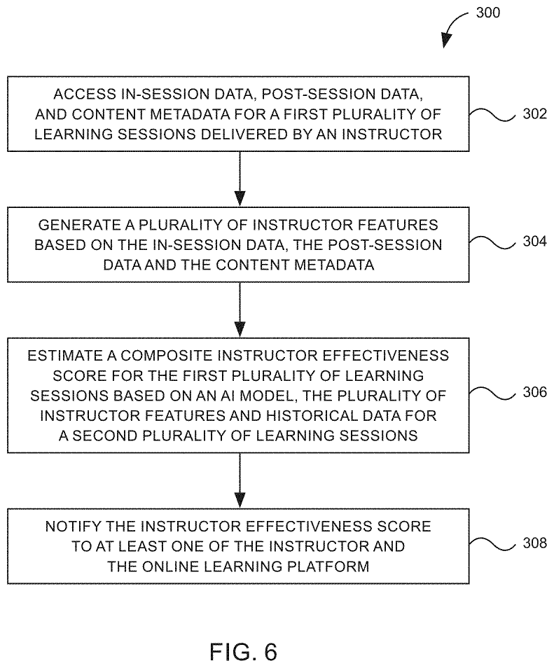

Referring now to FIG. 5, an instructor effectiveness score estimation system 200 in accordance with some embodiments of the present description is illustrated. The system 200 includes a data module 210, a memory 215 storing one or more processor-executable routines, and a processor 220 communicatively coupled to the memory 215. The processor 220 includes a feature generator 222, an effectiveness score estimator 224, and a notification module 226. Each of these components is further described in detail earlier with reference to FIG. 4. The processor 220 is configured to execute the processor-executable routines to perform the steps illustrated in the flow chart of FIG. 6.

FIG. 6 is a flowchart illustrating a method 300 for estimating instructor effectiveness scores in interactive learning sessions delivered via an online learning platform. The method 300 may be implemented using the systems of FIGS. 4 and 5, according to some aspects of the present description. Each step of the method 300 is described in detail below.

At step 302, the method 300 includes accessing in-session data, post-session data, and content metadata for a first plurality of learning sessions delivered by an instructor. In some embodiments, the in-session data further includes a learner metric for each learning session of the first plurality of learning sessions. Definitions and examples of in-session data, post-session data, and content metadata are provided herein earlier.

At step 304, the method 300 includes generating a plurality of instructor features based on the in-session data, the post-session data, and the content metadata. The plurality of instructor features may be generated using one or more AI models.

The method 300, further includes, at step 308, estimating a composite instructor effectiveness score for the first plurality of learning sessions based on an AI model, the plurality of instructor features and historical data for a second plurality of learning sessions, wherein the second plurality of learning sessions corresponds to a learning goal and a learning topic that is same as the first plurality of learning sessions. Non-limiting examples of suitable AI models include long short-term memory network, convolutional neural network, or a combination thereof.

Step 308 may further include estimating an individual instructor effectiveness score for each learning session of the first plurality of learning sessions, wherein the composite instructor effectiveness score is estimated based on the individual instructor effectiveness scores. In some embodiments, step 308 may further include splitting the composite instructor effectiveness score into two or more of a whiteboard usage score, a content usage score, an interaction score, a behavior score, a pedagogical score, or an emotional score.

At step 310, the method includes notifying the instructor effectiveness score to at least one of the instructor and the online learning platform. In some embodiments, step 310 includes notifying the composite instructor effectiveness score to the instructor after the first plurality of learning sessions are completed. In some embodiments, the instructor may be able to access the scores via a personal dashboard on the online learning platform. FIG. 7 is a plot showing an example composite instructor effectiveness score 401 and a baseline instructor effectiveness score 402. FIG. 8 shows an example of the split of the composite effectiveness score 501 into a whiteboard usage score, an interaction score, and a content usage score vis-à-vis a baseline instructor effectiveness score 502.

In some embodiments, step 310 includes notifying the instructor effectiveness scores to the online learning platform, and the scores may be employed by the online learning platform to assess an instructor's performance vis-à-vis a baseline score and/or performance of other instructors on the online platform.

In some embodiments, the method 300 may further include transmitting one or more pedagogical suggestions to the instructor if the composite effectiveness score is below a threshold effectiveness score. The method 300 may further include transmitting one or more pedagogical suggestions (e.g., change in pedagogy, increased use of whiteboard module, etc.) to the instructor based on one or more of the whiteboard usage score, the content usage score, the interaction score, the behavior score, the pedagogical score, or the emotional score. FIG. 9 shows examples of pedagogical instructions notified to an instructor.

The instructor, in some embodiments, may make one or more changes in the delivery of the subsequent learning sessions, based on the composite effectiveness score and/or one or more suggestions. Thus, the systems and methods of the present description may enable changes in the delivery of a learning session by the instructor, based on the effectiveness scores.

The systems and methods described herein may be partially or fully implemented by a special purpose computer system created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium, such that when run on a computing device, cause the computing device to perform any one of the aforementioned methods. The medium also includes, alone or in combination with the program instructions, data files, data structures, and the like. Non-limiting examples of the non-transitory computer-readable medium include, but are not limited to, rewriteable non-volatile memory devices (including, for example, flash memory devices, erasable programmable read-only memory devices, or a mask read-only memory devices), volatile memory devices (including, for example, static random access memory devices or a dynamic random access memory devices), magnetic storage media (including, for example, an analog or digital magnetic tape or a hard disk drive), and optical storage media (including, for example, a CD, a DVD, or a Blu-ray Disc). Examples of the media with a built-in rewriteable non-volatile memory, include but are not limited to memory cards, and media with a built-in ROM, including but not limited to ROM cassettes, etc. Program instructions include both machine codes, such as produced by a compiler, and higher-level codes that may be executed by the computer using an interpreter. The described hardware devices may be configured to execute one or more software modules to perform the operations of the above-described example embodiments of the description, or vice versa.

Non-limiting examples of computing devices include a processor, a controller, an arithmetic logic unit (ALU), a digital signal processor, a microcomputer, a field programmable array (FPA), a programmable logic unit (PLU), a microprocessor, or any device which may execute instructions and respond. A central processing unit may implement an operating system (OS) or one or more software applications running on the OS. Further, the processing unit may access, store, manipulate, process, and generate data in response to the execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

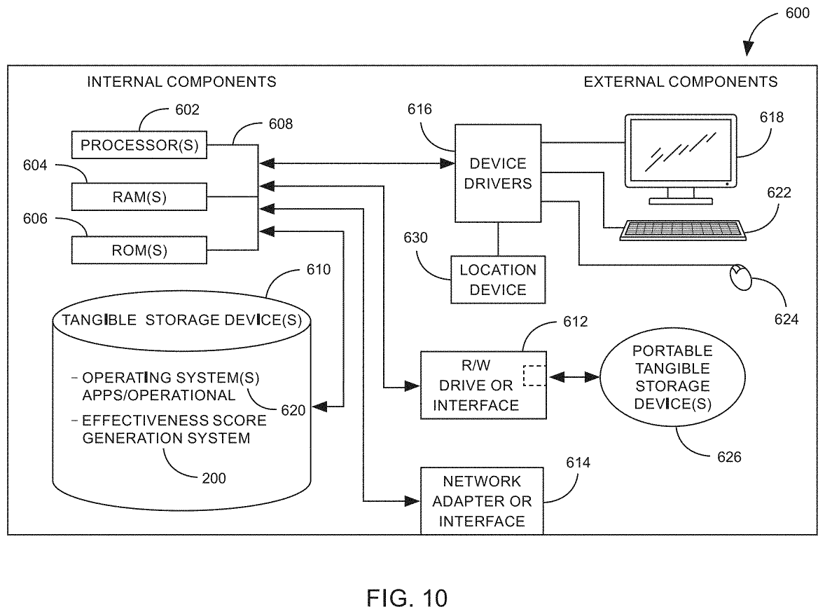

One example of a computing system 600 is described below in FIG. 10. The computing system 600 includes one or more processor 602, one or more computer-readable RAMs 604, and one or more computer-readable ROMs 606 on one or more buses 608. Further, the computer system 608 includes a tangible storage device 610 that may be used to execute operating systems 620 and the effectiveness score estimation system 200. Both, the operating system 620 and the effectiveness score estimation system 200 are executed by processor 602 via one or more respective RAMs 604 (which typically includes cache memory). The execution of the operating system 620 and/or effectiveness score estimation system 200 by the processor 602, configures the processor 602 as a special-purpose processor configured to carry out the functionalities of the operation system 620 and/or the effectiveness score estimation system 200, as described above.

Examples of storage devices 610 include semiconductor storage devices such as ROM 506, EPROM, flash memory, or any other computer-readable tangible storage device that may store a computer program and digital information.

Computing system 600 also includes a R/W drive or interface 612 to read from and write to one or more portable computer-readable tangible storage devices 626 such as a CD-ROM, DVD, memory stick, or semiconductor storage device. Further, network adapters or interfaces 614 such as a TCP/IP adapter cards, wireless Wi-Fi interface cards, or 3G or 4G wireless interface cards, or other wired or wireless communication links are also included in the computing system 600.

In one example embodiment, the effectiveness score estimation system 200 may be stored in tangible storage device 610 and may be downloaded from an external computer via a network (for example, the Internet, a local area network, or another wide area network) and network adapter or interface 614.

Computing system 600 further includes device drivers 616 to interface with input and output devices. The input and output devices may include a computer display monitor 618, a keyboard 622, a keypad, a touch screen, a computer mouse 624, and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

While only certain features of several embodiments have been illustrated and described herein, many modifications and changes will occur to those skilled in the art. It is, therefore, to be understood that the appended claims are intended to cover all such modifications and changes as fall within the scope of the invention and the appended claims.

1. A system for determining instructor effectiveness scores for interactive learning sessions delivered via an online learning platform to a plurality of learners, the system comprising:
a data module operatively coupled to the online learning platform and a computing device used by an instructor to deliver the online learning sessions, the data module configured to access in-session data, post-session data, and content metadata for a first plurality of learning sessions delivered by the instructor; and
a processor operatively coupled to the data module, the processor comprising:
a feature generator configured to generate a plurality of instructor features based on the in-session data, the post-session data, and the content metadata;
a score estimator configured to estimate a composite instructor effectiveness score for the first plurality of learning sessions based on an AI model, the plurality of instructor features, and historical data for a second plurality of learning sessions, wherein the second plurality of learning sessions corresponds to a learning goal and a learning topic that is same as the first plurality of learning sessions; and
a notification module configured to notify the instructor effectiveness score to at least one of the instructor and the online learning platform.

2. The system of claim 1, wherein the in-session data comprises one or more of whiteboard data, audio data, video data, content data, or interaction data for the instructor corresponding to each learning session of the first plurality of learning sessions.

3. The system of claim 2, wherein the in-session data further comprises a learner metric for each learning session of the first plurality of learning sessions.

4. The system of claim 1, wherein the post-session data comprises one or more of feedback survey data, learner conversion data, learner churn data, or post-session assessment data.

5. The system of claim 1, wherein the score estimator is further configured to estimate an individual instructor effectiveness score for each learning session of the first plurality of learning sessions, and wherein the composite instructor effectiveness score is estimated based on the individual instructor effectiveness scores.

6. The system of claim 1, wherein the processor further comprises a training module configured to train the AI model based on at least one of a learner metric or a manual evaluation data corresponding to one or more learning sessions of the first plurality of learning sessions.

7. The system of claim 1, wherein the notification module is configured to transmit one or more pedagogical suggestions to the instructor if the composite effectiveness score is below a threshold effectiveness score.

8. The system of claim 1, wherein the score estimator is further configured to split the composite instructor effectiveness score into two or more of a whiteboard usage score, a content usage score, an interaction score, a behavior score, a pedagogical score, or an emotional score.

9. The system of claim 8, wherein the notification module is further configured to transmit one or more pedagogical suggestions to the instructor based on one or more of the whiteboard usage score, the content usage score, the interaction score, the behavior score, the pedagogical score, or the emotional score.

10. A system for determining instructor effectiveness scores in interactive learning sessions delivered via an online learning platform to a plurality of learners, the system comprising:
a memory storing one or more processor-executable routines; and
a processor cooperatively coupled to the memory, the processor configured to execute the one or more processor-executable routines to:
access in-session data, post-session data, and content metadata for a first plurality of learning sessions delivered by an instructor;
generate a plurality of instructor features based on the in-session data, the post-session data, and the content metadata;
estimate a composite instructor effectiveness score for the first plurality of learning sessions based on an AI model, the plurality of instructor features and historical data for a second plurality of learning sessions, wherein the second plurality of learning sessions corresponds to a learning goal and a learning topic that is same as the first plurality of learning sessions; and
notify the instructor effectiveness score to at least one of the instructor and the online learning platform.

11. The system of claim 10, wherein the processor is further configured to execute the one or more processor-executable routines to estimate an individual instructor effectiveness score for each learning session of the first plurality of learning sessions, and wherein the composite instructor effectiveness score is estimated based on the individual instructor effectiveness scores.

12. The system of claim 10, wherein the processor is further configured to execute the one or more processor-executable routines to train the AI model based on at least one of a learner metric or a manual evaluation data corresponding to one or more learning sessions of the first plurality of learning sessions.

13. The system of claim 10, wherein the processor is further configured to execute the one or more processor-executable routines to transmit one or more pedagogical suggestions to the instructor if the composite effectiveness score is below a threshold effectiveness score.

14. The system of claim 10, wherein the processor is further configured to execute the one or more processor-executable routines to split the composite teacher effectiveness score into a whiteboard usage score, a content usage score, an interaction score, a behavior score, a pedagogical score, or an emotional score.

15. The system of claim 14, wherein the processor is further configured to execute the one or more processor-executable routines to transmit or more pedagogical suggestions to the instructor based on one or more of the whiteboard usage score, the content usage score, the interaction score, the behavior score, the pedagogical score, or the emotional score.

16. A method for determining instructor effectiveness scores for interactive learning sessions delivered via an online learning platform, the method comprising:
accessing in-session data, post-session data, and content metadata for a first plurality of learning sessions delivered by an instructor;
generating a plurality of instructor features based on the in-session data, the post-session data and the content metadata;
estimating a composite instructor effectiveness score for the first plurality of learning sessions based on an AI model, the plurality of instructor features and historical data for a second plurality of learning sessions, wherein the second plurality of learning sessions corresponds to a learning goal and a learning topic that is same as the first plurality of learning sessions; and
notifying the instructor effectiveness score to at least one of the instructor and the online learning platform.

17. The method of claim 16, further comprising estimating an individual instructor effectiveness score for each learning session of the first plurality of learning sessions, and estimating the composite instructor effectiveness score based on the individual instructor effectiveness scores.

18. The method of claim 16, further comprising training the one or more individual instructor effective scores based on at least one of a learner metric or a manual evaluation data corresponding to one or more learning sessions of the first plurality of learning sessions.

19. The method of claim 16, further comprising splitting the composite teacher effectiveness score into a whiteboard usage score, a content usage score, an interaction score, a behavior score, a pedagogical score, or an emotional score.

20. The method of claim 19, further comprising transmitting one or more pedagogical suggestions to the instructor based on one or more of the whiteboard usage score, the content usage score, the interaction score, the behavior score, the pedagogical score, or the emotional score.
